(19) United States
(12) Patent Application Publication
(10) Pub. No.: US 2008/0154867 A1
(43) Pub. Date: Jun. 26, 2008

(54) System and Method for Automatic Text Summarization using a Search Engine

(76) Inventors: Shai Ophir, (US); Neomi Ophir, (US)

Correspondence Address: Shai Ophir;P.O.Box 12, Hanoar St., Moshav Ein-Vered, 40696, omitted

(21) Appl. No.: 11/612,492

(22) Filed: Dec. 19, 2006

Related U.S. Application Data
(60) Provisional application No. 60/775,084, filed on Feb. 22, 2006.

(51) Int. Cl. G06F 17/30

(52) U.S. Cl. 707/4; 707/E17.014

(57) ABSTRACT

A system and method for automatic text summarization, the method comprising the steps of:
Separation of the given text into sentences,
For each sentence—building its own search expression,
For each search expression—searching a relevant information domain using a search engine, where the same information domain and search engine is being used for all search expressions created for the given text,
Selecting a pre-defined number of sentences with the fewest matching results,
Concatenating the selected sentences, according to their original order of appearance, hereby creating the summary of the original text.

### RELATIONSHIP TO EXISTING APPLICATIONS

The present application claims priority from U.S. Provisional Patent Application No. 60/775,084 filed Feb. 22, 2006, the content of which are hereby incorporated by reference.

### FIELD AND BACKGROUND OF THE INVENTION

Text Summarization is one of the difficult tasks in the field of NPL: natural Langauge Processing. The huge amount of textual information accumulated on the Internet make it impossible for the ordinary and skilled person in the art to read all relevant information for her needs or interest. Text summarization tools could provide a partial solution for the information flow problem. Extracting the main issues and ideas out of a pile of text, screening the most relevant pieces of data would make our life much easier. However this task requires a high degree of natural language understanding, a degree which probably can not be achieved in the foreseen future. This invention proposes an alternative solution for the problem of text summarization, a solution which its main engine is not based on natural language analysis and understanding.

One of the common methods for text summarization is based on selecting the most important sentences out of a given text. The selected sentences are not modified, but remain as is. The summarized text is not a re-write then, but a selection of a sub-group of original sentences among the group of all sentences composing the text. Since a sentence usually has its own meaning, without the need for associations with other sentences, the new sub-group of sentences will be a meaningful text. If the selected sentences are the most important sentences of the original text, containing the most important ideas and the most novel information, their collection will represent the main ideas and novelty of the original text. It is usually the case that there are some sentences which are more important than the others in a specific text, which contain the main points of the text.

This invention describes a new system and method for selecting the most relevant sentences for the summarization.

### SUMMARY OF THE INVENTION

This invention describes a new system and method for selecting the most relevant sentences out of a given text, creating automatic summary of the text. A sentence is a collection of words. If a sentence contains new information, or a novel idea, the relation between its words expressing the new information will be less common, less being used by people so far. The more the sentence brings new information to the table, the more the relation between its components is surprising, less anticipated, less predicted. This is due to the essence of new information: contributing new relations between concepts, objects, terms etc.

Based on this principle, we can use the search engines, such as the internet search engines: Google, AltaVista, Yahoo and others, to rank the degree of novelty of a sentence. The most significant sentences will be the ones with the fewest matches (the fewest search results).

Note that this principle is not applicable for all types of texts. It is applicable for texts which aim to bring new information, or claim for new arguments, such as research papers. The invention can not help high school students for summarizing classic history texts, since these texts are not aiming to bring new analysis or conclusions.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

According to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWING

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawing:

FIG. 1 describes the system of the invention as a simplified block diagram. The system is composed of five functional components, which will be described in the following.

### DESCRIPTION OF THE PREFERRED EMBODIMENTS

As already indicated, one of the common methods for text summarization is based on selecting the most important sentences out of a given text. The present embodiments describe a new system and method for selecting the most relevant sentences for text summarization.

A sentence is a collection of words. If a sentence contains new information, or a novel idea, the relation between its words expressing the new information will be less common, less being used by people so far. The more the sentence brings new information to the table, the more the relation between its components is surprising, less anticipated, less predicted. This is due to the essence of new information: contributing new relations between concepts, objects, terms etc.

Note that this principle is not applicable for all types of texts. It is applicable for texts which aim to bring new information, or claim for new arguments, such as research papers. The invention can not help high school students for summarizing classic history texts, since these texts are not aiming to bring new analysis or conclusions.

Based on this principle, we can use the internet search engines, such as Google, Altavista, Yahoo and others, to rank the degree of novelty of a sentence. If we take the whole sentence, as a collection of words, and search the internet for all these words, we'll see that the more the sentence is novel and innovative, the less matching results we get by the search. Note the search operation will be performed for all the words of the sentence, with an ‘AND’ relation inserted between them (the conjunction relation), i.e. searching resources that contains all of these words together. We do not search of course the whole sentence as a one string, enveloped by string delimiters. For example, if the sentence is compose of four words: word1 word2 word3 word4, we'll search for the following search expression: word1 AND word2 AND word3 AND word4. We'll not search for “word1 word2 word3 word4” as a one string.

Note also that the invention is not so limited. There are some search engines which assume the AND operator as a default between a sequence of words given to be searched. In that case, there is no need to insert the AND relation between the words of the sentence.

Note also that in some cases, some of the words may be removed from the search expression. That depends on the existence of additional software, which is capable of doing grammatical analysis, and distinguishes between significant and non-significant words of the sentence. For example, the subject of the sentence is a significant word, while the word “the” is not significant. However the existence of such sub-system is not mandatory.

The process therefore for text summarixation is as follows:

1. Separate the text into sentences

2. For each sentence build its search expression: a sequence of all of its words, separated by AND (unless the search engine implements the AND relation as the default between given words in a search expression).

3. Optionally use grammatical filter to remove non-significant words.

4. For each sentence, search the internet or any other relevant information domain with its search expression, using a search engine such as Google (as it is in early 2006). Store the number of matches (the number of results), along with the sentence identifier, in a table/database.

5. After searching all sentences, select the sentences with the fewer matches/results to be the most significant sentences of the text. The summarization of the text will be the concatenation of these sentences into one text, according to their original order of appearance.

6. The number of selected sentences can be configured by the user. If the user would like to summary to include 10% of the original text, 10% will be selected, the 10% with the fewer matching results, as explained. If the user would like only 5% to be included in the summary, 5% of the sentences will be selected.

7. For example, the original text was composed of 10 sentences: S1, S2, S3, S4, S5, S6, S7, S8, S9, and S10. The user is interested in summarization of 30% that is 3 sentences should be selected. The sentence with the least matching results was S8, then S3, then S6. The summarized text will be then S3, S6, and S8, concatenated.

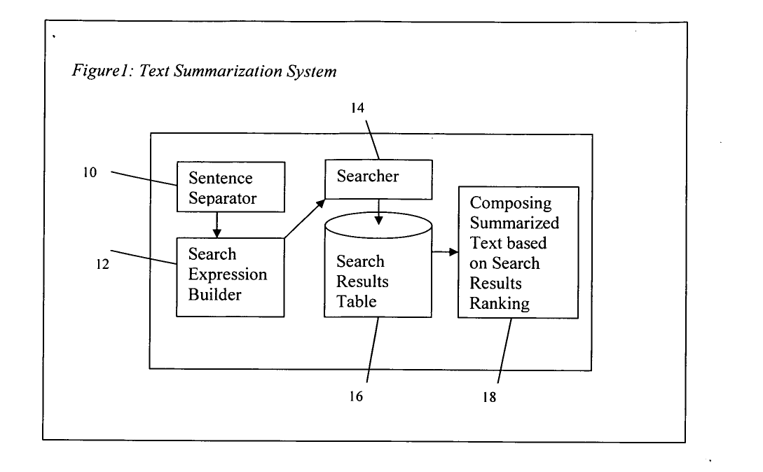

### FIG. 1 Describes the System of the Invention.

Component (10) is the sentence separator which receives the input text and separates it into sentences.

Component (12) is the search expression builder, which build the search expression for each sentence, as described in the above.

Component (14) is the searcher itself, searching the internet or any other electronic information domain using a computerized search engine.

Component (16) is the table for storing the number of matches for all sentences.

Component (18) is the composer of the summarized text, composing it by selecting the sentences with the fewer matches, as described in the above.

Although the application mentions the Google search engine in specific, it is expected that during the life cycle of the patent there will be other relevant search engines and other relevant information domains, except of the internet (which may be a subset of the internet). Hence, this patent application is not so limited to specific search engines and the internet electronic information domain.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for an automatic summarization of text, comprising of:
A separator unit, for separating a given text into sentences
A search expression builder unit, for building the search expression for each one of the sentences,
A searcher unit, accessing a search engine with the search expressions for searching in an electronic information domain
A table unit, for storing the matching results of all sentences
A composer unit, for composing the summarization by selecting sentences having the fewest matching results, then concatenating these sentences according to their original order.

2. The system of claim 1, where the separator unit is using sentence delimiters ”.”, “!”, “?” and other known delimiters for separation the text into sentences

3. The system of claim 1, where the search expression for a sentence is a concatenation of all the words of the sentence, separated by “AND”, the logical conjunction as commonly used by search engines.

4. The system of claim 1, wherein the electronic information domain is the internet.

5. The system of claim 1, wherein the search engine can be one of Google, Yahoo, MSN

6. The system of claim 1, where the amount of selected sentences by the composer unit, for the summary, can be determined by the user of the system.

7. A method for automatic text summarization, comprising the steps of:
Separation of the given text into sentences,
For each sentence—building its own search expression,
For each search expression—searching a relevant information domain using a search engine, where the same information domain and search engine is being used for all search expressions created for the given text,
Selecting a pre-defined number of sentences with the fewest matching results,
Concatenating the selected sentences, according to their original order of appearance, hereby creating the summary of the original text.

8. The method of claim 7, where the search expression of a sentence is a sequence of all of the words of the sentence, separated by the AND logical expression.

9. The method of claim 7, where the relevant information domain is the internet

10. The method of claim 7, where the search engine is Google, Yahoo, MSN

11. The method of claim 7, where the pre-defined number of sentences will be determined by the user of the system.
